(19) United States
(12) Patent Application Publication
(10) Pub. No.: US 2002/0167729 A1
(43) Pub. Date: Nov. 14, 2002

(54) Optical diffraction element, method of fabricating the same and optical pickup apparatus using the same

(75) Inventor: Tetsuo Saeki, Osaka (JP)

Correspondence Address: Dike, Bronstein, Roberts & Cushman, Intellectual Property Practice Group, Edwards & Angell, LLP, 130 Water Street, Boston, MA, 02109, US

(73) Assignee: Sharp Kabushiki Kaisha, Osaka (JP)

(21) Appl. No.: 10/142,710

(22) Filed: May 10, 2002

(30) Foreign Application Priority Data
May 11, 2001 (JP) P2001-141936

(51) Int. Cl. G02B 5/18

(52) U.S. Cl. 359/569

(57) ABSTRACT

An object of the invention is to provide an optical diffraction element capable of obtaining optimum diffraction efficiency ratios through a plurality of respective diffraction elements, a method of fabricating the optical diffraction element through one process, and an optical pickup apparatus by using the optical diffraction element. The optical diffraction element comprises a first diffraction element and a second diffraction element of which a pitch is smaller than that of the first diffraction element, a duty of the first diffraction element is smaller than that of the second diffraction element.

### BACKGROUND OF THE INVENTION

1. Field of the Invention

This invention relates to an optical diffraction element, a method of fabricating the same, and an optical pickup apparatus using the optical diffraction element for reproducing an optical disk.

2. Description of the Related Art

Optical disks have now been widely used as media for recording music, image and data. A variety of apparatuses have been developed for recording and reproducing data into, and from, the optical disk. Among them, it has been desired to develop an optical pickup apparatus in a small size, in a highly integrated form and featuring high performance.

The applicant has already proposed an optical pickup apparatus 300 shown in FIG. 10 aimed at reducing the size in a highly integrated form. The optical pickup apparatus 300 is constituted by a stem 301, a semiconductor laser 302 which is a source of light provided on the stem 301, a cap 303 for covering the stem 301, a light-transmitting substrate 304 mounted on the cap 303, a half-wavelength plate 305 mounted on the light-transmitting substrate 304, a beam splitter 306 mounted on the half-wavelength plate 305, a collimating lens 307 for turning a beam of light emitted from the semiconductor laser 302 into a parallel beam, an objective lens 308 for focusing the parallel beam from the collimating lens 307 onto a magnetic-optic recording medium 309, and a light detector 310 arranged on the stem 301 to detect light branched by the beam splitter 306 and reflected by the magnetic-optic recording medium 309.

The beam splitter 306 is constituted by a first member 315 made of a glass material and a second member 316 made of a material having double refraction. A polarizer/separator film is formed on a boundary surface between the first member 315 and the second member 316.

In the light-transmitting substrate 304, there are formed a first diffraction element 312 and a second diffraction element 311 thereby to constitute an optical diffraction element 317.

A beam of light emitted from the semiconductor laser 302 passes through the first diffraction element 312 so as to be separated into three beams of light, i.e., a beam of transmitted light (main beam) and ± primary diffracted beams (sub-beams), which, then, pass through the half-wavelength plate 305, reflected by the first plane 313 and the second plane 314 of the beam splitter 306, pass through the collimating lens 307 and the objective lens 308, and are focused on the magnetic-optic recording medium 309.

The beams of light reflected by the magnetic-optic recording medium 309 are separated by the second plane 314 of the beam splitter 306 into normal light and abnormal light at an angle of refraction determined by a ratio of the refractive index of the first member 315 and refractive index for normal light and abnormal light of the second member 316. The thus separated six beams fall on the second diffraction element 311 disposed thereunder.

FIG. 11 is a plan view of the optical diffraction element 317 obtained by forming the first diffraction element 312 and the second diffraction element 311 in the light-transmitting substrate 304. Referring to FIG. 11, the second diffraction element 311 is divided into first to third regions 311a to 311c, and the six beams falling on the second diffraction element 311 are further separated into 18 beams of transmitted light and diffracted light, which are, then, focused on the light detector 310.

FIG. 12 is a diagram illustrating spots focused on the light detector 310. Among the six beams that have transmitted through the second diffraction element 311, the normal light component of the main beam falls on a light detector portion 310f, the abnormal light component of the main beam falls on a light detector portion 310e, the normal light components and abnormal light components of the sub-beams fall on light detector portions 310g and 310h, respectively.

Among the six beams diffracted by the first region 311a of the second diffraction element 311, the normal light component and the abnormal light component of the main beam fall on the boundary between a light detector portion 310c and a light detector portion 310d.

Among the six beams diffracted by the second region 311b of the second diffraction element 311, the normal light component and the abnormal light component of the main beam fall on a light detector portion 310b.

Among the six beams diffracted by the second region 311c of the second diffraction element 311, the normal light component and the abnormal light component of the main beam fall on a light detector portion 310a.

By operating a difference in the signals output from the light detector portions 310c and 310d, a focus error signal is obtained based on a knife-edge method. By operating a difference in the signals output from the light detector portions 310g and 310h, a radial error signal is obtained based on a three-beam method. By operating a difference in the signals output from the light detector portions 310a and 310b, a so-called push-pull signal is obtained. The push-pull signals are used for detecting address signals recorded in a meandering manner in the magnetic-optic recording medium 309. A magnetic-optic signal is obtained by operating a difference in the signals output from the light detector portions 310e and 310f.

This optical pickup apparatus 300 features a good light utilization efficiency since there is no extra light-branching element in the optical path through which the beam of light emitted from the semiconductor laser 302 arrives at the magnetic-optic recording medium 309, except the first member 315 of the beam splitter 306 and the first diffraction element 312. Further, since the magnetic-optic signal, focus error signal and radial error signal are all detected by the common light detector 310, the area of the light detector 310 can be decreased on the stem 301, and the optical pickup apparatus 300 can be realized in a small size and at a decreased cost.

When an optical diffraction element is to be fabricated by forming diffraction elements in the light-transmitting substrate, in general, use is made of a reactive ion etching apparatus (hereinafter referred to as RIE apparatus).

FIG. 13 is a sectional view of a general diffraction element. The pitch stands for a width v from a given recessed portion of a diffraction element to a neighboring recessed portion, the groove width stands for a width w of the recessed portion of the diffraction element, the duty stands for a ratio w/v of the groove width to the pitch, and the groove depth stands for a depth d of the recessed portion.

FIG. 6 is a graph illustrating a relationship between the etching time and the etching depth depending upon the groove width of when the duty is set to 0.5. Even when the etching time (t) is the same, the etching efficiency increases with an increase in the groove width (w₀>w₁>w₂), and, hence, the groove depth increases (d₀>d₁>d₂).

FIG. 7 is a graph illustrating a relationship between the groove depth of the diffraction element and the diffraction efficiency. From this graph, when the duty w/v is set to a constant value, i.e., w/v=0.5, the 0-degree diffraction efficiency decreases and the primary diffraction efficiency increases with an increase in the groove depth.

In the optical diffraction element 317 which is a constituent part of the optical pickup apparatus 300 described above, the first diffraction element 312 has a pitch larger than that of the second diffraction element 311. These diffraction elements have a duty which is 0.5, respectively. When the groove widths of these diffraction elements are compared, therefore, the first diffraction element 312 has a larger groove width. When optimum groove widths are compared, further, the first diffraction element 312 has a smaller groove depth.

When it is attempted to simultaneously form the first diffraction element 312 and the second diffraction element 311 in the light-transmitting substrate 304 by effecting the etching for the same period of time by using the RIE apparatus, therefore, the first diffraction element 312 having a larger groove width is formed acquiring a larger groove depth. Accordingly, optimum groove depths of the diffraction elements are not accomplished.

Concretely speaking, when the etching time is so adjusted that the second diffraction element 311 assumes an optimum groove depth, the first diffraction element 312 is formed to acquire a groove depth larger than the optimum value, since the groove width of the first diffraction element 312 is larger than the groove width of the second diffraction element 311. Accordingly, the primary diffraction efficiency of the first diffraction element 312 becomes greater than a designed value. That is, the quantity of ± primary diffracted light diffracted by the first diffraction element 312 becomes larger than the designed value, and a decreased quantity of light transmits to the optical disk 309 passing through the first diffraction element 312. Therefore, the signal to noise ratio decreases, and the quality of the reproduced signals is deteriorated.

Conversely, when the etching time is so adjusted that the first diffraction element 312 acquires an optimum groove depth, the second diffraction element 311 is formed to acquire a groove depth smaller than the optimum value, since the groove width of the second diffraction element 311 is smaller than the groove width of the first diffraction element 312. Accordingly, the primary diffraction efficiency of the second diffraction element becomes smaller than a designed value. That is, the quantity of ± primary diffracted light diffracted by the second diffraction element 311 becomes smaller than the designed value, and an increased quantity of light transmits through the second diffraction element 311. Therefore, a decreased quantity of light is diffracted by the second diffraction element 311 and is guided to the light detector portions 310a to 310d, causing a decrease in the quality of the focus servo signals and address signals and making it difficult to stably conduct the focusing and addressing.

At present, therefore, the etching has been conducted through two processes so that the two diffraction elements 311 and 312 are formed to obtain optimum groove depths. That is, the diffraction elements 311 and 312 are not formed simultaneously in the light-transmitting substrate 304. Instead, the first diffraction element 312 only is formed, first, and, then, the second diffraction element 311 is formed to constitute a desired optical diffraction element 317.

According to this method of fabrication, however, the number of the fabrication steps is doubled and, besides, the first diffraction element 312 and the second diffraction elements 311 must be precisely positioned, making it difficult to mass-produce the apparatuses at a decreased cost.

### SUMMARY OF THE INVENTION

This invention provides an optical diffraction element capable of obtaining optimum diffraction efficiency ratios (primary diffraction efficiency: 0-degree diffraction efficiency) through each diffraction element, a method of fabricating the optical diffraction element through one process, and an optical pickup apparatus by using the optical diffraction element.

This invention provides an optical diffraction element comprising:

a first diffraction element; and

a second diffraction element of a pitch smaller than that of the first diffraction element,

wherein a duty of the first diffraction element is smaller than that of the second diffraction element.

In the invention it is preferable that the duty of the second diffraction element is 0.5 and the duty of the first diffraction element is smaller than 0.5.

According to the invention, each diffraction element has an optimum duty corresponding to the pitch thereof, and there is provided an optical diffraction element capable of exhibiting optimum diffraction efficiency ratios.

The invention further provides a method of fabricating an optical diffraction element comprising a first diffraction element and a second diffraction element of which a pitch is smaller than that of the first diffraction element, relying upon a photolithography technology, the method comprising:

forming the first diffraction element and the second diffraction element simultaneously by using a photomask which renders the duty of the first diffraction element to be smaller than that of the second diffraction element.

According to the invention, since the photomask that enables each of diffraction elements to obtain optimum duties corresponding to the pitches thereof is used, each of diffraction elements obtain optimum groove depths. Therefore, optimum diffraction efficiency ratios are obtained. Besides, since the first diffraction element and the second diffraction element are simultaneously formed, the plurality of diffraction elements having different pitches can be formed through a single process. It is therefore possible to form the plurality of diffraction elements precisely and cheaply.

In this invention, further, it is preferable that the photomask is the one which renders the duty of the first diffraction element to be smaller than 0.5.

According to the invention, since the photomask that renders the duty of the first diffraction element to be smaller than 0.5 is used, the first diffraction element obtains an optimum groove depth. Therefore, an optimum diffraction efficiency ratio is obtained from the first diffraction element.

The invention further provides a method of fabricating an optical diffraction element comprising a first diffraction element and a second diffraction element which have different pitches, relying upon a photolithography technology, the method comprising:

forming the first diffraction element and the second diffraction element simultaneously by being exposed to light through a single photomask having two kinds of light-transmitting portions of different transmittances.

According to the invention, since the single photomask having two kinds of light-transmitting portions of different transmittances, each of diffraction elements can obtain optimum groove depths. It is, therefore, possible to obtain diffraction elements having optimum diffraction efficiency ratios. Besides, since the first diffraction element and the second diffraction element are simultaneously formed, the plurality of diffraction elements having different pitches can be formed through a single process. It is therefore possible to form a plurality of diffraction elements precisely and cheaply.

The invention further provides an optical pickup apparatus comprising:

a source of light for generating a beam of light;

a first diffraction element for separating the beam of light emitted from the source of light into a plurality of beams of light;

focusing means for focusing the beams of light that have passed through the first diffraction element onto an optical recording medium;

a beam splitter arranged between the first diffraction element and the focusing means;

a light detector arranged in the same package as the source of light; and

a second diffraction element for diffracting the light that has passed through the beam splitter and is reflected by the optical recording medium, and for guiding the light to the light detector;

wherein the first diffraction element and the second diffraction element are formed in one light-transmitting substrate, and have different duties.

In the invention it is preferable that the duty of the first diffraction element is smaller than that of the second diffraction element.

In the invention it is preferable that the duty of the second diffraction element is 0.5 and the duty of the first diffraction element is smaller than 0.5.

According to the invention, since the apparatus has the first diffraction element and the second diffraction element which are formed in one light-transmitting substrate and have different duties, each of diffraction elements obtain optimum groove depths and optimum diffraction efficiency ratios. Therefore it is possible to provide an optical pickup apparatus which efficiently utilizes light and is capable of stably reproducing the signals recorded in an optical disk. Further, since the first and second diffraction elements are formed through a single process, the optical pickup apparatuses can be mass-produced at decreased costs.

### BRIEF DESCRIPTION OF THE DRAWINGS

Other and further objects, features, and advantages of the invention will be more explicit from the following detailed description taken with reference to the drawings wherein:

FIG. 1 is a view illustrating the constitution of an optical pickup apparatus 18 according to an embodiment of the invention;

FIG. 2 is a plan view of an optical diffraction element 17;

FIG. 3 is a diagram illustrating spots focused on a light detector 7 of the optical pickup apparatus 18 according to an embodiment of the invention;

FIG. 4 is a flowchart illustrating the steps for fabricating the optical diffraction element 17;

FIGS. 5A to 5E are views showing in simplified from processes in each step (a) to (e) of FIG. 4;

FIG. 6 is a graph illustrating a relationship between the etching time and the etching depth depending upon the groove width of the diffraction element;

FIG. 7 is a graph illustrating a relationship between the groove depth and the diffraction efficiency of a diffraction element;

FIGS. 8A and 8B are sectional views of the diffraction element of before the duty is adjusted and after the duty is adjusted;

FIGS. 9A and 9B are sectional views of a first diffraction element 5 and of a second diffraction element 6 formed in the optical diffraction element 17;

FIG. 10 is a view illustrating the constitution of a conventional optical pickup apparatus 300;

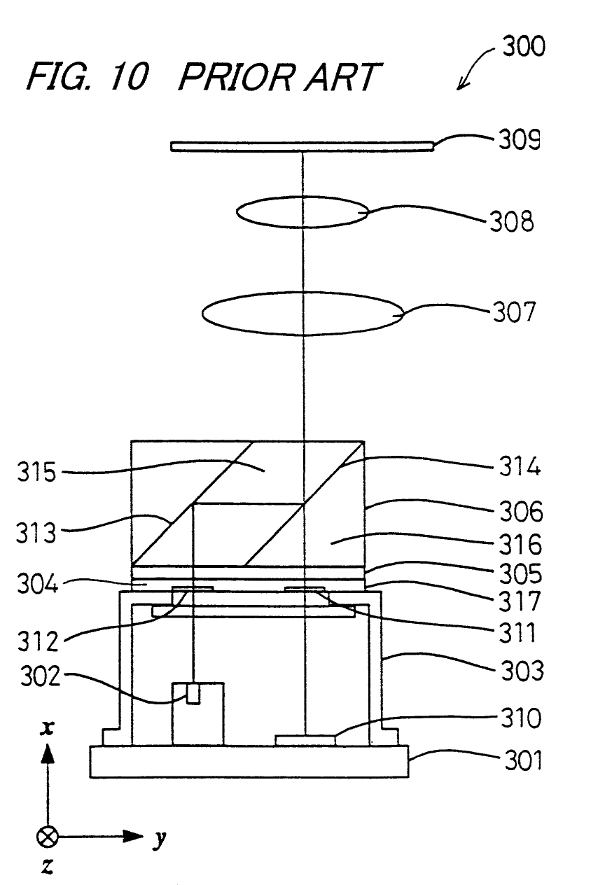

FIG. 11 is a plan view of an optical diffraction element 317 possessed by the conventional optical pickup apparatus 300;

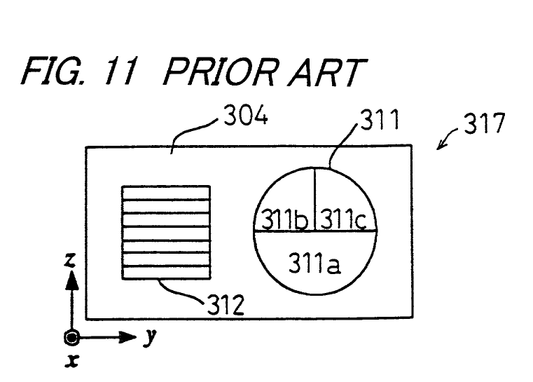

FIG. 12 is a diagram illustrating spots focused on a light detector 310 of the conventional optical pickup apparatus 300; and

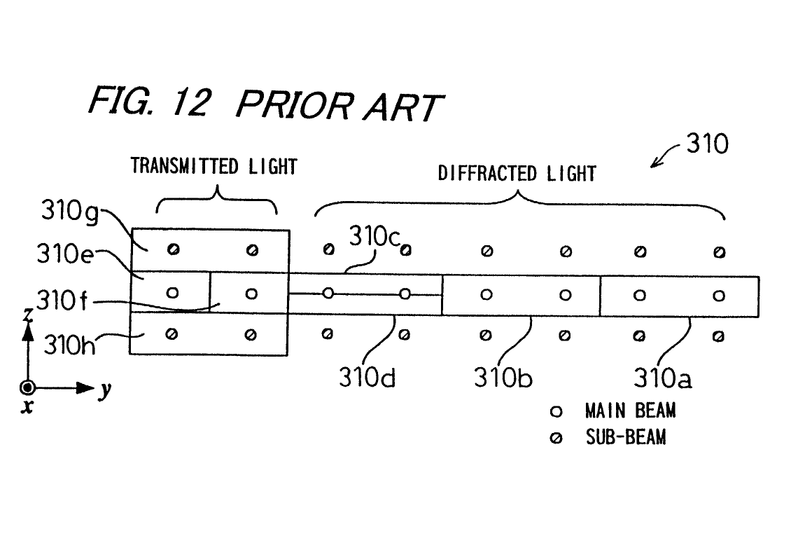

FIG. 13 is a sectional view of a general diffraction element.

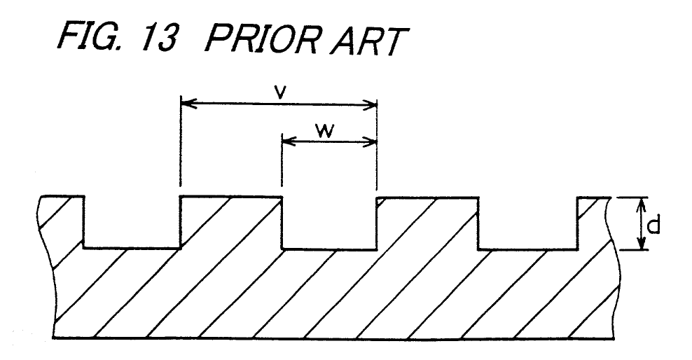

### DETAILED DESCRIPTION OF THE PREFERRED EMBODIMENTS

Now referring to the drawings, preferred embodiments of the invention are described below.

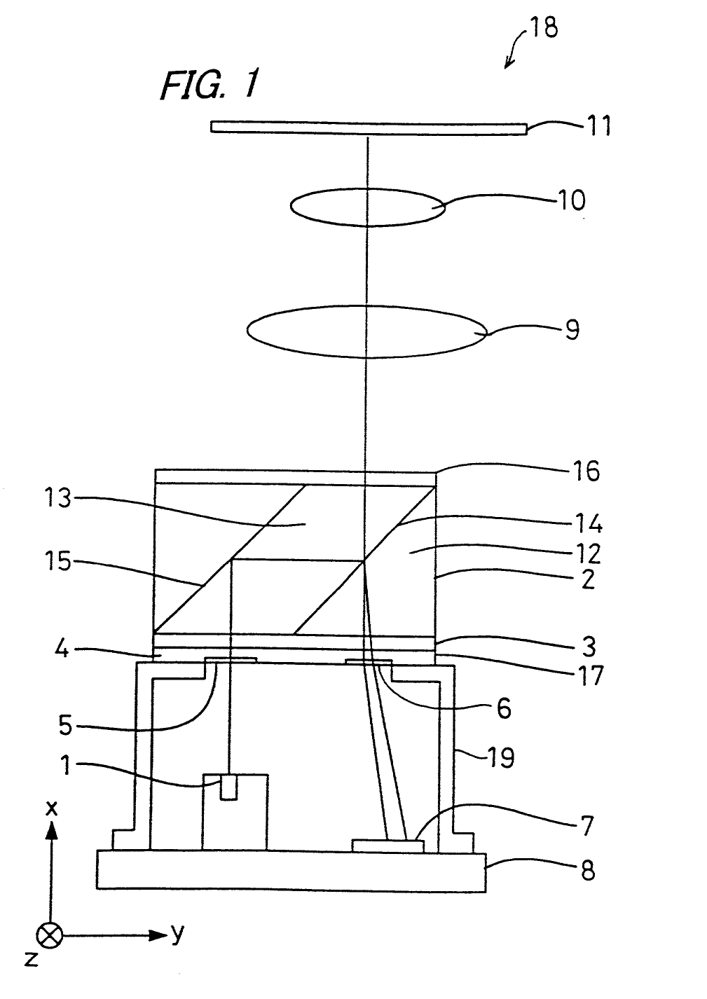

FIG. 1 is a view schematically illustrating an optical pickup apparatus 18 according to an embodiment of the invention. The optical pickup apparatus 18 reads out signals recorded on a magnetic-optic recording medium 11.

The optical pickup apparatus 18 includes a stem 8, a source of light 1 disposed on the stem 8 to emit a beam of light, a cap 19 covering the stem 8, an optical diffraction element 17 arranged on the cap 19 and having a first diffraction element 5 and a second diffraction element 6 juxtaposed to the first diffraction element 5 and formed simultaneously therewith in a light-transmitting substrate 4, a collimating lens 9 for turning the beam of light emitted from the source of light 1 into a parallel beam, an objective lens 10 for focusing the parallel beam from the collimating lens 9 onto a magnetic-optic recording medium 11, a beam splitter 2 arranged between the source of light 1 and the collimating lens 9, constituted by a first member 13 of anisotropic material and a second member 12 of an anisotropic material, and has a polarizer/separator film on a plane 14 where the first member 13 and the second member 12 are stuck together, a half-wavelength plate 3 disposed between the beam splitter 2 and the source of light 1, a half-wavelength plate 16 disposed between the beam splitter 2 and the collimating lens 9, and a light detector 7 constituted in the same package as the source of light 1.

The beam of light emitted from the source of light 1 passes through the first diffraction element 5 and is separated into three beams of light, which, then pass through the half-wavelength plate 3 so as to be converted into s-polarized light. The beams of light that have passed through the half-wavelength plate 3 are reflected by the second plane 15 and by the first plane 14, pass through the half-wavelength plate 16 so as to be converted into p-polarized light, which, then, pass through the collimating lens 9 and the objective lens 10 and are focused on the optical disk 11. The beams of light reflected by the optical disk 11 pass through the objective lens 10, collimating lens 9 and half-wavelength plate 16, are separated on the first plane 14 into two polarized lights intersecting at right angles, and further pass through the half-wavelength plate 3. A total of six beams of light that have passed through the half-wavelength plate 3 fall on the second diffraction element 6 formed in the light-transmitting substrate 4 juxtaposed to the first diffraction element 5 as described above.

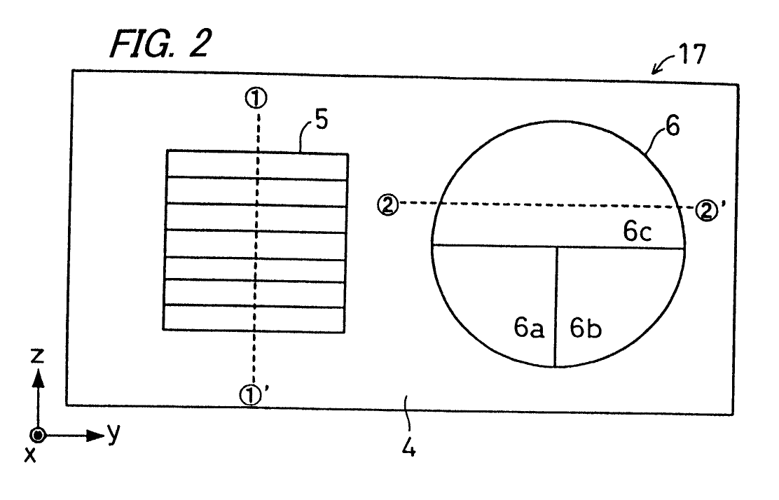

FIG. 2 is a plan view of the optical diffraction element 17. The optical diffraction element 17 includes the first diffraction element 5 and the second diffraction element 6 formed in one light-transmitting substrate 4. When the first diffraction element 5 is compared with the second diffraction element 6, the first diffraction element 5 has a pitch larger than that of the second diffraction element 6, and has a duty smaller than that of the second diffraction element 6. As shown in FIG. 2, further, the second diffraction element 6 is divided into three, i.e., into first to third regions 6a to 6c.

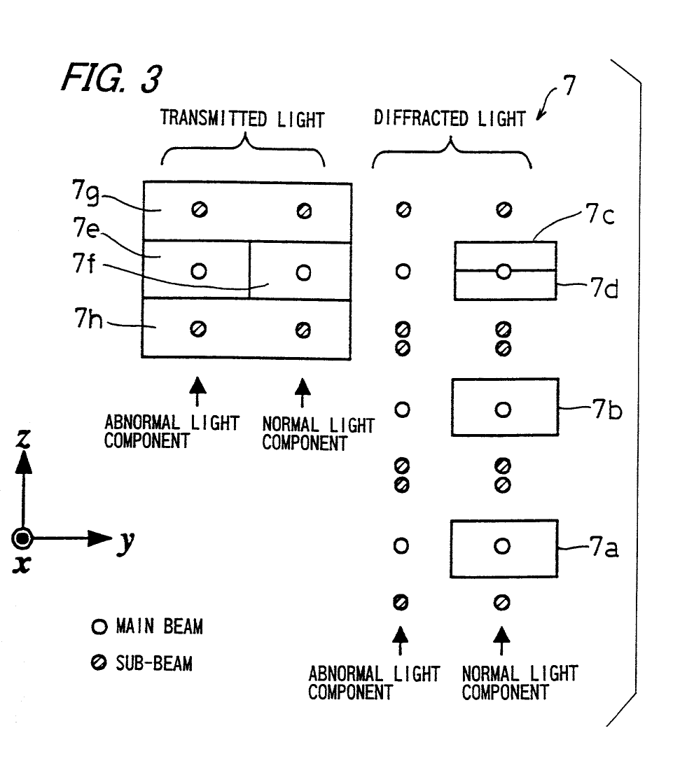

The light detector 7 detects signals by utilizing light that has transmitted through, and is diffracted by, the second diffraction element 6. FIG. 3 is a diagram illustrating spots focused on the light detector 7.

Among the six beams that have transmitted through the second diffraction element 6, a normal light component of a main beam is focused on a light detector portion 7f, an abnormal light component of the main beam is focused on a light detector portion 7e, a normal light component and an abnormal light component of a sub-beam are focused on light detector portions 7g and 7h, respectively.

Among the six beams diffracted by the first region 6c of the second diffraction element 6, the normal light component of the main beam is focused on the boundary between the light detector portion 7c and the light detector portion 7d.

Among the six beams diffracted by the second region 6b of the second diffraction element 6, the normal light component of the main beam is focused on the light detector portion 7b.

Among the six beams diffracted by the third region 6a of the second diffraction element 6, the normal light component of the main beam is focused on the light detector portion 7a.

By finding a difference between the light detector portions 7c and 7d of the light detector 7, a focus error signal is detected based on the Foucault's method. By finding a difference between the light detector portions 7a and 7b of the light detector 7, an address signal is detected. By finding a difference between the light detector portions 7e and 7f of the light detector 7, a magnetic-optic signal is detected. By finding a difference between the light detector portions 7g and 7h of the light detector 7, a radial error signal is detected based on the 3-beam method.

The first diffraction element 5 has an optimum duty and makes it possible to obtain an optimum diffraction efficiency ratio. Therefore, a favorable signal to noise ratio is obtained, and the reproduced signals feature a high quality. The second diffraction element 6, too, has an optimum duty and makes it possible to obtain an optimum diffraction efficiency ratio. Therefore, there are obtained favorable focus servo signals and address signals, and the focusing and addressing are stably conducted.

The optical diffraction element 17 having the first diffraction element 5 and the second diffraction element 6 of different duties, is used for the optical pickup apparatus 18. Namely, there is provided an optical pickup apparatus 18 which features good light utilization efficiency, which can be mass-produced, and which is capable of stably reproducing the signals recorded in the optical disk.

Next, described below is a method of fabricating the optical diffraction element 17.

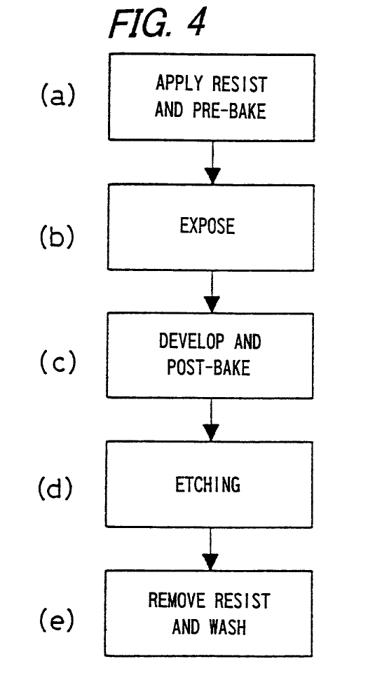

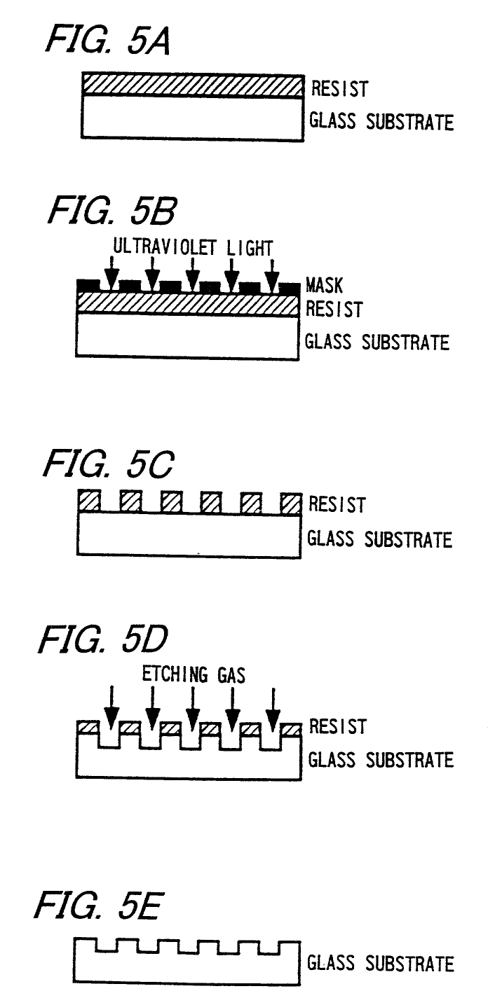

FIG. 4 is a flowchart illustrating the steps of fabricating the optical diffraction element 17 by forming the first diffraction element 5 and the second diffraction element 6 simultaneously in the glass substrate which is the light-transmitting substrate 4 relying upon the photolithography technology. FIGS. 5A to 5E are views showing in simplified from processes in each step (a) to (e) of FIG. 4.

At step (a), as shown in FIG. 5A, first, a photosensitive resist is uniformly applied onto the glass substrate by using a spin coater and is, then, pre-baked.

Then, at step (b), as shown in FIG. 5B, the resist on the glass substrate is exposed to light by using a photomask having a pattern which enables the diffraction elements 5 and 6 to possess optimum duties. The photomask has been so designed that the second diffraction element 6 possesses a duty ratio of 0.5. As for the first diffraction element 5, the duty ratio is so set that the first diffraction element 5 possesses the optimum diffraction efficiency ratio when the second diffraction element 6 is formed by being etched for an optimum period of time.

Then, at step (c), as shown in FIG. 5C, the resist exposed to light is developed, and is post-baked. Through up to this step, a resist pattern for the first diffraction element 5 and for the second diffraction element 6 has been formed on the glass substrate.

Then, at step (d), as shown in FIG. 5D, the glass substrate in which the resist pattern for the first diffraction element 5 and for the second diffraction element 6 has been formed, is subjected to the etching by using an RIE apparatus. The etching time is selected to be best suited for forming the second diffraction element 6.

Then, at step (e), as shown in FIG. 5E, the resist remaining on the glass substrate is removed by washing to thereby form the first diffraction element 5 and the second diffraction element 6.

Described below is how to optimize the duty of the first diffraction element 5 at the above step (b) in FIG. 4.

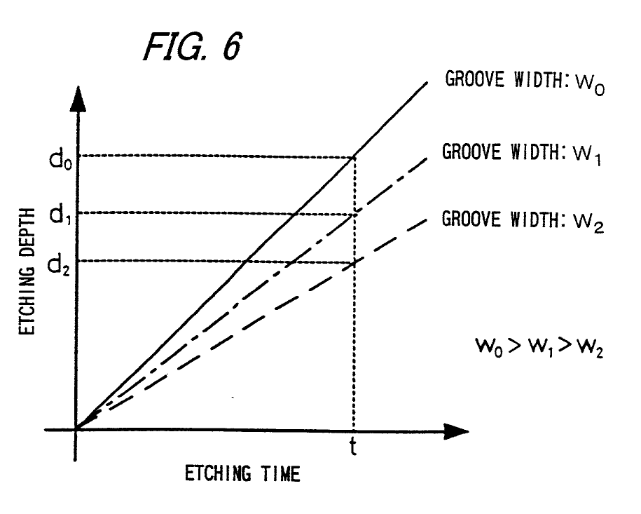

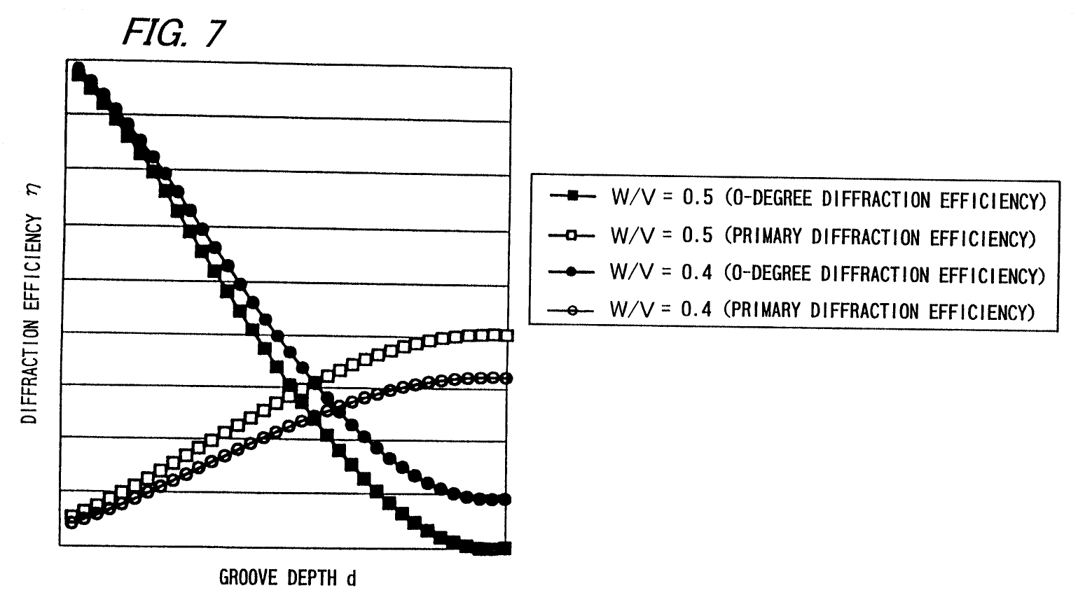

Described below is a relationship among the duty, groove width, groove depth and diffraction efficiency. Referring to FIG. 6 mentioned above, when the etching is conducted for the same period of time, the groove depth decreases with a decrease in the groove width. Referring to FIG. 7 mentioned above, further, when the duty is the same, i.e., when the groove width is the same, the 0-degree diffraction efficiency increases and the primary diffraction efficiency decreases with a decrease in the groove depth. As shown in FIG. 7, further, even when the groove depth is the same, the 0-degree diffraction efficiency increases with a decrease in the duty, i.e., with a decrease in the groove width.

In order to obtain an optimum diffraction efficiency based upon the above relationship among the duty, groove width, groove depth and diffraction efficiency, therefore, the duty of the first diffraction element 5 is set to be not larger than 0.5.

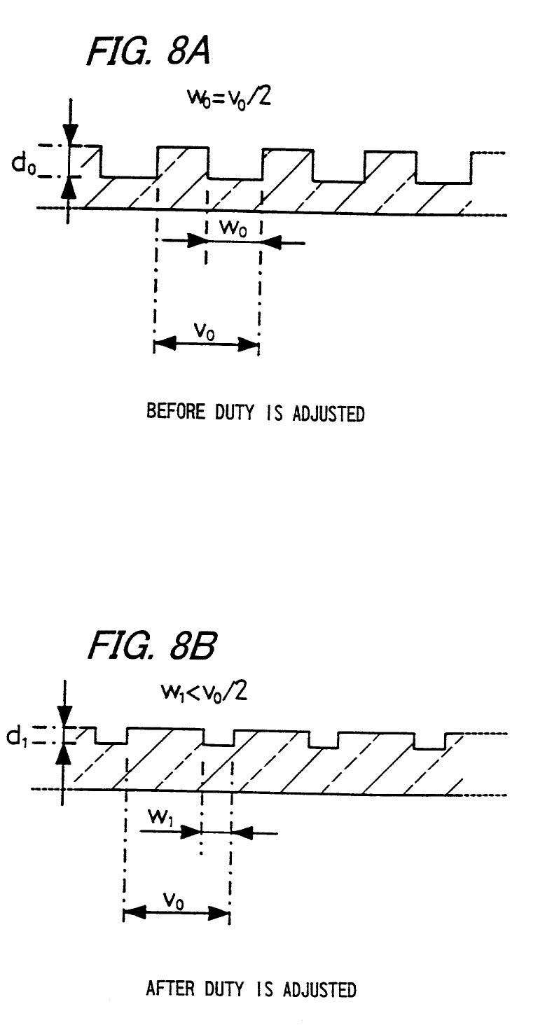

FIGS. 8A and 8B are sectional views of the diffraction element of before the duty is adjusted and after the duty is adjusted. FIG. 8A is a sectional view when the diffraction element of a pitch v₀ has a duty 0.5 and FIG. 8B is a sectional view when the duty is adjusted to be smaller than 0.5. The respective diffraction elements shown in FIGS. 8A and 8B are etched for the same period of time. When the duty of the diffraction element is changed, and the groove width is decreased from w₀ down to w₁, then, the groove depth formed after the etching time of t decreases from d₀ down to d₁ as shown in FIG. 6.

Here, as compared to the diffraction element having a duty of 0.5, an increased 0-degree diffraction efficiency and a decreased primary diffraction efficiency are exhibited by the diffraction element of which the duty is adjusted to be smaller than 0.5 relying upon the synergistic effect stemming from the rise in the 0-degree diffraction efficiency due to a decreased duty and from the rise in the 0-degree diffraction efficiency due to a decreased groove depth as shown in FIG. 7.

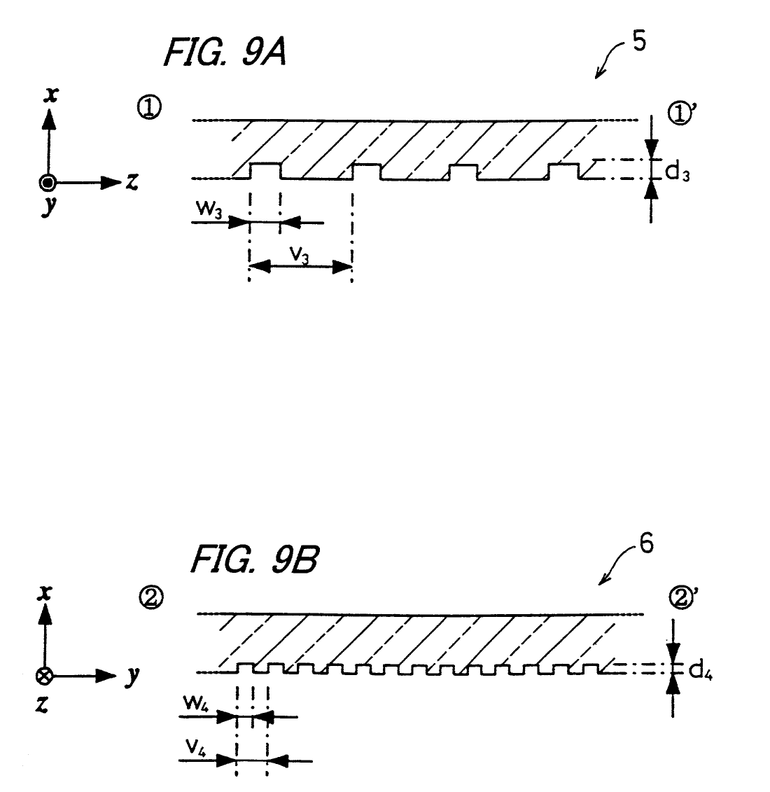

FIG. 9A is a sectional view taken along line \mathring{1}-\mathring{1}′ of the first diffraction element 5 possessed by the optical diffraction element 17 of FIG. 2, and FIG. 9B is a sectional view taken along line \mathring{2}-\mathring{2}′ of the second diffraction element 6 possessed by the optical diffraction element 17 of FIG. 2. The first diffraction element 5 has a pitch v₃ and the second diffraction element 6 has a pitch v₄.

The second diffraction element 6 has a groove width w₄ and a duty w₄/v₄ of 0.5. As for the first diffraction element 5, the duty is adjusted based on the above relationship so that the first diffraction element 5 assumes an optimum diffraction efficiency ratio when the etching is conducted for a period of time that is best suited for fabricating the second diffraction element 6. Relying upon this adjustment, the groove width of the first diffraction element 5 is set to be w₃ and its duty w₃/v₃ is set to be smaller than 0.5.

Thus, the duty of the first diffraction element is set to be smaller than the duty of the second diffraction element, and a photomask is formed based thereupon. By using this photomask, the first diffraction element 5 and the second diffraction element 6 are simultaneously formed relying upon the photolithography technology. The first diffraction element 5 that is formed possesses a groove depth d₃, and the second diffraction element 6 possesses a groove depth d₄. The groove depth d₃ of the first diffraction element 5 is smaller than the groove depth that is obtained by the conventional method.

As described above, the first diffraction element 5 and the second diffraction element 6 having desired diffraction efficiency ratios and having different pitches are fabricated through one process by suitably setting the duty of the first diffraction element 5, and utilizing the synergistic effect based upon the rise in the 0-degree diffraction efficiency due to a decreased groove width and upon the rise in the 0-degree diffraction efficiency due to a decreased groove depth as a result of a decreased groove width.

### EXAMPLE

A first diffraction element and a second diffraction element having a pitch smaller than that of the first diffraction element were formed on a glass substrate by the fabrication method of the present invention.

The first diffraction element possessed a pitch of 20 μm and the second diffraction element possessed a pitch of 5 μm. The photomask was so formed that their duties were 0.45 and 0.5, respectively. A resist was applied by using a spin coater onto the glass substrate, was exposed to light through the photomask that was intimately adhered thereto, developed, baked and etched. The first and second diffraction elements formed through one time of process were measured for their average groove depths to be 0.259 μm for the first diffraction element and 0.254 μm for the second diffraction element. Further, their diffraction efficiencies were measured to calculate diffraction efficiency ratios. The first diffraction element exhibited a diffraction efficiency ratio of 1:10.5 and the second diffraction element exhibited a diffraction efficiency ratio of 1:9.9, which were both optimum ratios.

### Comparative Example

A first diffraction element and a second diffraction element having a pitch smaller than that of the first diffraction element were formed on a glass substrate by the conventional method.

The first diffraction element possessed a pitch of 20 μm and the second diffraction element possessed a pitch of 5 μm. The photomask was so prepared that their duties were 0.5, respectively. The diffraction elements were formed in the same manner as in Example, and their groove depths were measured to be 0.261 μm for the first diffraction element and 0.254 μm for the second diffraction element. Further, their diffraction efficiencies were measured to calculate diffraction efficiency ratios. The first diffraction element exhibited a diffraction efficiency ratio of 1:8.2 and the second diffraction element exhibited a diffraction efficiency ratio of 1:9.9. Thus, the second diffraction element exhibited an optimum diffraction efficiency ratio, but the first diffraction element did not exhibit an optimum diffraction efficiency ratio.

According to the above method, the duty of the first diffraction element is changed to design a photomask which optimizes the diffraction efficiency ratio of the first diffraction element even when the etching is conducted for a period of time best suited for forming the second diffraction element. It is, however, also possible to so form the respective diffraction elements as to exhibit optimum diffraction efficiency ratios by using a half-tone photomask for exposing the first diffraction element to light and by using a normal photomask for exposing the second diffraction element to light.

In exposing the photoresist formed on the glass substrate to light, a normal photomask having a transmittance in the light-transmitting portion of 100% is used for the second diffraction element, and a photomask having a transmittance in the light-transmitting portion of smaller than 100% is used for the first diffraction element. When exposed to light by using the above photomask and is developed, the photoresist of the portion of the second diffraction element exposed to light all peels off, but the photoresist of the portion of the first diffraction element exposed to light does not at all peel off but remains. When the light-transmitting substrate is etched in a state where the patterns of the first diffraction element and of the second diffraction element are transferred onto the photoresist, the photoresist that is remaining causes the groove depth of the first diffraction element to become smaller than the groove depth of when the light-transmitting substrate is etched by being exposed to light using the normal photomask.

Therefore, the etching rate of the photoresist and the etching rate of the substrate are measured in advance, and the transmittance of the light-transmitting portion of the photomask used for exposing the first diffraction element to light is set to be smaller than 100% relying upon these rates. By using the photomask having the transmittance of the light-transmitting portion which is set to be smaller than 100% for forming the first diffraction element, the first diffraction element acquires an optimum groove depth despite the etching is effected for a period of time to give an optimum groove depth to the second diffraction element, and a desired diffraction efficiency ratio is accomplished.

By forming the first diffraction element and the second diffraction element by the method of fabricating the optical diffraction element by using the above half-tone photomask, it is made possible to form a plurality of diffraction elements having optimum diffraction efficiency ratios on a glass substrate through one process.

In the foregoing was described the method of fabricating the optical diffraction element of the invention with reference to the case of the optical diffraction element of the transmission type. The invention, however, can be applied to the optical diffraction element of the reflection type, too.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical diffraction element comprising:
a first diffraction element; and
a second diffraction element of a pitch smaller than that of the first diffraction element,
wherein a duty of the first diffraction element is smaller than that of the second diffraction element.

2. The optical diffraction element of claim 1, wherein the duty of the second diffraction element is 0.5 and the duty of the first diffraction element is smaller than 0.5.

3. A method of fabricating an optical diffraction element comprising a first diffraction element and a second diffraction element of which a pitch is smaller than that of the first diffraction element, relying upon a photolithography technology, the method comprising:
forming the first diffraction element and the second diffraction element simultaneously by using a photomask which renders the duty of the first diffraction element to be smaller than that of the second diffraction element.

4. The method of claim 3, wherein the photomask is the one which renders the duty of the first diffraction element to be smaller than 0.5.

5. A method of fabricating an optical diffraction element comprising a first diffraction element and a second diffraction element which have different pitches, relying upon a photolithography technology, the method comprising:
forming the first diffraction element and the second diffraction element simultaneously by being exposed to light through a single photomask having two kinds of light-transmitting portions of different transmittances.

6. An optical pickup apparatus comprising:
a source of light for generating a beam of light;
a first diffraction element for separating the beam of light emitted from the source of light into a plurality of beams of light;
focusing means for focusing the beams of light that have passed through the first diffraction element onto an optical recording medium;
a beam splitter arranged between the first diffraction element and the focusing means;
a light detector arranged in the same package as the source of light; and
a second diffraction element for diffracting the light that has passed through the beam splitter and is reflected by the optical recording medium, and for guiding the light to the light detector;
wherein the first diffraction element and the second diffraction element are formed in one light-transmitting substrate, and have different duties.

7. The optical pickup apparatus of claim 6, wherein the duty of the first diffraction element is smaller than that of the second diffraction element.

8. The optical pickup apparatus of claim 6, wherein the duty of the second diffraction element is 0.5 and the duty of the first diffraction element is smaller than 0.5.
